(19) United States
(12) Patent Application Publication
(10) Pub. No.: US 2012/0110597 A1
(43) Pub. Date: May 3, 2012

(54) DETERMINING MULTI-PROGRAMMING LEVELS

(76) Inventors: Lyle Harold Ramshaw, Palo Alto, CA (US); Harumi Kuno, Cupertino, CA (US); Janet L. Wiener, Palo Alto, CA (US); William K. Wilkinson, San Mateo, CA (US); Umeshwar Dayal, Saratoga, CA (US); Stefan Krompass, Garching (DE)

(21) Appl. No.: 12/916,014

(22) Filed: Oct. 29, 2010

(51) Int. Cl. G06F 9/54

(52) U.S. Cl. 719/316

(57) ABSTRACT

An embodiment includes determining user loads and control parameter values. The determining control parameter values are mapped to a performance metric using a function. A constant performance metric is determined where the value of the function calculated at each control parameter value is less than said constant performance metric. An isocontour is defined based on the constant performance metric for each user load. Finally an operating envelope is calculated by correlating the isocontours of multiple user loads.

### BACKGROUND

Databases often handle large heterogeneous sets of queries that must be scheduled for processing. Moreover, queries often change due to the dynamic nature of workloads associated with the queries. Various tactics may be used to group and schedule the queries for processing in an efficient manner.

The processing of queries directly affects database performance. The numerous scheduling possibilities can result in database resources being either underutilized or saturated. Both processing extremes may represent poor use of the system.

### BRIEF DESCRIPTION OF THE DRAWINGS

Certain exemplary embodiments are described in the following detailed description and in reference to the drawings, in which:

FIG. 1A is a block diagram of a system that may operate at multi-programming levels according to an embodiment;

FIG. 1B is a block diagram of a system that may operate at multi-programming levels according to an embodiment;

FIG. 2A is a diagram showing isocontours and level sets for two concurrent user loads according to an embodiment;

FIG. 2B is a diagram showing isocontours and level sets for two concurrent user loads according to an embodiment;

FIG. 2C is a diagram showing throughput and response time isocontours for two concurrent user loads according to an embodiment;

FIG. 3 is a process flow diagram showing a computer-executed method for determining multi-programming levels according to an embodiment;

FIG. 4A is a process flow diagram showing a computer-executed method for determining multi-programming levels according to an embodiment;

FIG. 4B is a process flow diagram showing a computer-executed method for determining multi-programming levels according to an embodiment;

FIG. 5 is a diagram showing an expansion phase according to an embodiment;

FIG. 6 is a diagram showing a visualization of the Fibonacci algorithm according to an embodiment;

FIG. 7 is a diagram showing a visualization of a Zig-Zag search sequence according to an embodiment; and

FIG. 8 is a block diagram showing a tangible, machine-readable medium that stores code adapted to determining multi-programming levels according to an embodiment.

### DETAILED DESCRIPTION

Embodiments of the invention provide an efficient tool for processing queries using appropriate multi-programming level (MPL) settings. For each combination of MPL settings, points are strategically selected to test and search for an operating envelope that encompasses satisfactory settings for all user loads, even when the service level objectives are heterogeneous.

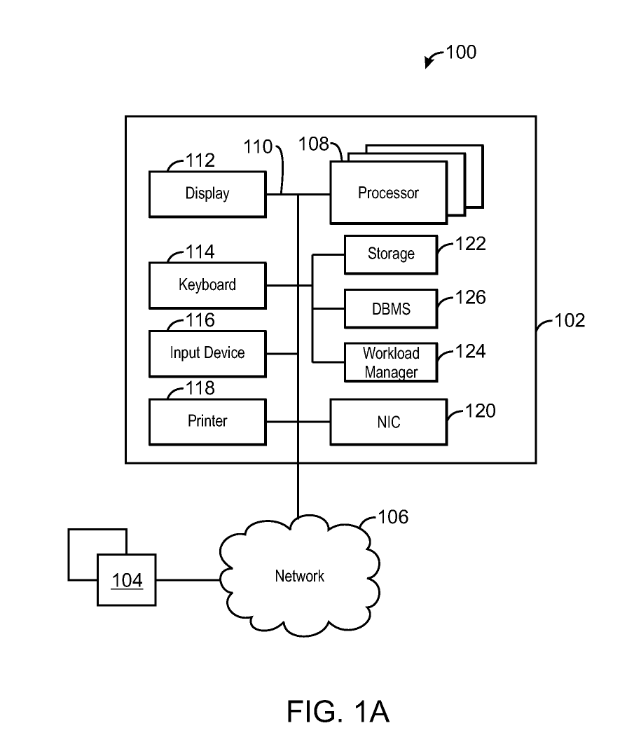

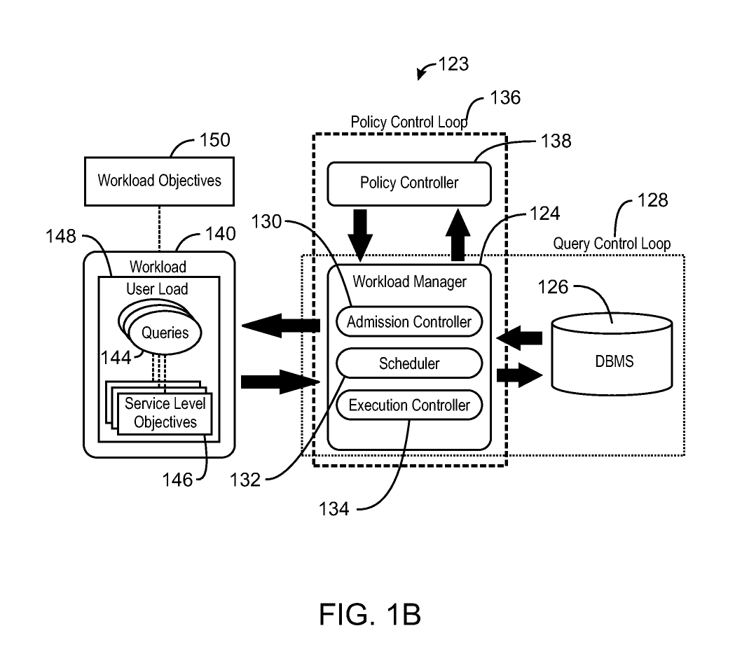

FIG. 1A is a block diagram of a system that may operate at multi-programming levels according to an embodiment. The system is generally referred to by the reference number 100. Those of ordinary skill in the art will appreciate that the functional blocks and devices shown in FIG. 1A may comprise hardware elements including circuitry, software elements including computer code stored on a tangible, a machine-readable medium, or a combination of both hardware and software elements. Additionally, the functional blocks and devices of the system 100 are but one example of functional blocks and devices that may be implemented in an embodiment. Those of ordinary skill in the art would readily be able to define specific functional blocks based on design considerations for a particular electronic device.

The system 100 may include a server 102, and one or more client computers 104, in communication over a network 106. As illustrated in FIG. 1A, the server 102 may include one or more processors 108 which may be connected through a bus 110 to a display 112, a keyboard 114, one or more input devices 116, and an output device, such as a printer 118. The input devices 116 may include devices such as a mouse or touch screen. The processors 108 may include a single core, multiples cores, or a cluster of cores in a cloud computing architecture. The server 102 may also be connected through the bus 110 to a network interface card (NIC) 120. The NIC 120 may connect the server 102 to the network 106.

The network 106 may be a local area network (LAN), a wide area network (WAN), or another network configuration. The network 106 may include routers, switches, modems, or any other kind of interface device used for interconnection. The network 106 may connect to several client computers 104. Through the network 106, several client computers 104 may connect to the server 102. The client computers 104 may be similarly structured as the server 102.

The server 102 may have other units operatively coupled to the processor 108 through the bus 110. These units may include tangible, machine-readable storage media, such as storage 122. The storage 122 may include any combinations of hard drives, read-only memory (ROM), random access memory (RAM), RAM drives, flash drives, optical drives, cache memory, and the like. The storage 122 may include the software used in an embodiment of the present techniques. For example, a workload manager 124 may utilize storage 122. In an embodiment, the workload manager 124 may interface with a database management system (DBMS) 126. Although the DBMS 126 and workload manager 124 are shown to reside on server 102, a person of ordinary skill in the art would appreciate that the DBMS 126 and workload manager 124 may reside on the server 102 or any of the client computers 104.

FIG. 1B is a block diagram of a system that may operate at multi-programming levels according to an embodiment. The system is generally referred to by the reference number 123. Those of ordinary skill in the art will appreciate that the functional blocks and devices shown in FIG. 1B may comprise hardware elements including circuitry, software elements including computer code stored on a tangible, a machine-readable medium, or a combination of both hardware and software elements. Additionally, the functional blocks and devices of the system 123 are but one example of functional blocks and devices that may be implemented in an embodiment. Those of ordinary skill in the art would readily be able to define specific functional blocks based on design considerations for a particular electronic device.

As illustrated, the system 123 may include a DBMS 126. The DBMS 126 can be part of the query control loop 128, along with workload manager 124. Workload manager 124 may include an admission controller 130, a scheduler 132, and an execution controller 134. The admission controller 130 determines which queries 144 should be rejected outright and which queries 144 should be admitted to the database system. The scheduler 132 determines when the DBMS 126 should run each query 144 and which queries 144 should run concurrently. The execution controller 134 determines what action to take, if any, upon an executing query 144. For example, the execution controller may suspend, kill, or abort and resubmit a running query 144. In an embodiment of the invention, the workload manager 124 and DBMS 126 can communicate with one another, such that the workload manager 124 and DBMS 126 can send messages to and receive messages from one another.

The workload manager 124 may also be a member of the policy control loop 136, along with policy controller 138. Although not displayed, the policy controller 138 may be a component of the workload manager 124. In an embodiment of the invention, the workload manager 124 and policy controller 138 can communicate with one another, such that the workload manager 124 and policy controller 138 can send messages to and receive messages from one another. The policy controller 138 may set rules by which the admission controller 130, scheduler 132, and execution controller 134 make decisions. The decisions made by the admission controller 130, scheduler 132, and execution controller 134 are used to ensure system conditions are within the operating envelope.

For example, the policy controller 138 may set a scheduling policy that specifies a threshold (upper limit) on the number of queries 144 that the scheduler 132 will schedule to execute simultaneously. This threshold is commonly referred to as an MPL.

A workload 140 consists of queries 144 and service level objectives 146. Service level objectives 146 may describe performance, such as average response time, throughput, and velocity and may be referred to as performance metrics or simply objectives. The queries 144 and service level objectives 146 taken in combination may form a user load 148. The workload 140 can contain n different user loads 148. In addition, workload objectives 150 can be provided to the workload 140. A complex workload objective 150 may include the possibility that a workload 140 contains multiple subsets of queries 144. Each subset of queries 144 may have distinct objectives. In an embodiment of the invention, the workload manager 124 and the workload 140 may be able to communicate with each other.

Each user load 148 may have one or more service level objectives 146 that can be formulated based on the performance metrics. For example, an Online Transaction Processing-type user load may have throughput and average response-time requirements, while a report-type user load 148 has a deadline. The workload manager 124 may set control parameters with regard to each user load 148. Control parameters may include the number of concurrently executing queries 144 corresponding to an MPL. The MPL associated with each user load can be a measure of estimated main memory consumption and control the processing of the respective user load. As a result, the MPL for each user load indirectly affects database performance.

Using the MPL, the workload manager 124 can identify and record, for any combination of user loads, the boundary for each user load between acceptable and unacceptable performance. These boundaries can be referred to as isocontours, due to the fact that instead of representing raw performance for a particular combination of MPL settings, they represent combinations of settings at which performance is at an acceptable level. The isocontours yield a model that can be intelligently searched to find control parameter settings that meet the service level objectives of all active user loads. In the event that no suitable control parameter settings exist, the search for such settings can gracefully fail.

Table 1 shows the nomenclature used in this approach.

TABLE 1
Nomenclature

| Symbol | Description |
|---|---|
| u | User load |
| U | Set of user loads |
| Fᵤ | Set of performance metrics that are relevant for user load |
| | u (e.g., throughput and average response time) |
| X | A tuple of length n that denotes a point in an n-dimensional |
| | space. The ith component of the tuple denotes the control |
| | parameter value for user load xᵢ |
| m_{f,u} | Perfomance measurement value of type f ∈ Fᵤ for user load u |
| [symbol] ᵤ(X) | Tuple [m_{f}_{₁}_{,u}, . . . , m_{f}_{ₖ}_{,u}] of performance measurement values |
| | for u taken with control parameter settings X |
| I_{f,u}(m_{f,u}) | f-isocontour for u for the designated performance value m_{f,u} |
| L_{f,u}(m_{f,u}) | f-level set for u for the designated performance value m_{f,u} |
| c_{f,u} | Performance objective that restricts f for user load u |
| Cᵤ | Tuple [c_{f}_{₁}_{,u}, . . . , c_{f}_{ₖ}_{,u}] of objectives defined for user load u |
| C | Set of objectives defined for all user loads in U |
| Oᵤ | Operating envelope; set of settings that satisfies the |
| | objectives for the user loads in U |

The equation Xε [symbol] ⁿ may be used to denote a tuple of n discrete control parameter values [xᵢ, . . . , xₙ], xᵢε [symbol] 1≦i≦n. Further, the term xᵢ may be used to denote the control parameter value for user load uᵢ, and the term ƒ may be used to denote a function that maps the control parameter values [x₁, . . . , xₙ] to a service level objective such as throughput or average response time. For ease of disclosure, the function ƒ can be required to return high values for “better performance.” This requirement may be trivial for service level objectives such as throughput. For service level objectives like average response time, function ƒ may return the negative value of the actual measurement, however, the negative value may correspond to better performance.

The term m may be used to denote a constant performance measurement as might be returned by ƒ(X). Accordingly, an isocontour with “height” m may be defined for a user load uᵢ as the set of tuples X=[x₁, . . . , xᵢ, . . . , xₙ] for which function ƒ(X) is greater than m. Further, evaluating function ƒ at tuples X′=[x₁, xᵢ₋₁, x′ᵢ, xᵢ₊₁, xₙ] with x′ᵢ>xᵢ results in a value less than m as shown in the following equation:

$${I}_{f} ( m ) = \{ X = [ {x}_{1} , … , {x}_{i} , … , {x}_{n} ] \vert f ( X ) \geq m ⋀ ∀ {X}^{′} = [ {x}_{1} , … , {x}_{i - 1} , {x}_{i}^{′} , {x}_{i + 1} , … , {x}_{n} ] , {x}_{i}^{′} > {x}_{i} \text{:} f ( {X}^{′} ) < m \}$$

In order to distinguish isocontours for different user loads, I_{ƒ,u} may represent the ƒ isocontour for a user load u₁. Accordingly, u₁ and u₂ may denote two user loads. The amount of queries processed for each user load is controlled with MPL. Further, m₁ and m₂ may denote the MPL values for u₁ and u₂, and tpᵢ([m₁, m₂]) may denote the throughput monitored with MPL settings. Thus, the throughput-isocontour for u₁ with performance of “height”

$${m}_{tp , {u}_{1} ,} = 1000 \frac{requests}{second}$$

is set of [m₁, m₂] values where the u₁ throughput at [m₁, m₂] is greater than or equal to

$$1000 \frac{requests}{second} ,$$

such that:

$${I}_{tp , {u}_{1}} ( {m}_{TP , {u}_{1}} ) = \{ [ {m}_{1} , {m}_{2} ] \vert {tp}_{1} ( [ {m}_{1} , {m}_{2} ] ) \geq 1000 \frac{requests}{second} ⋀ {tp}_{1} ( [ {m}_{1} + 1 , {m}_{2} ] ) < 1000 \frac{requests}{second}$$

A level set can denote the set of points L_{ƒ}(m)={X=[x₁, . . . , xₙ]|ƒ(X)>m}. The level set may represent all control parameter values that result in better performance, as described herein, than the performance value mapped by the isocontour. As a consequence, level sets for less restrictive performance values can contain the isocontours for “more restrictive” performance values, such that Lᵤ(c′ᵤ)⊂Lᵤ(cᵤ) if performance value c′ᵤ is more restrictive than performance value cᵤ. Appropriately, the shape of the isocontours and the resulting level sets depend on the resources available to process a user load. If L′ᵤ(cᵤ) represents the level set when fewer resources are available to the user load, such as when the user load is run on a “smaller” system, then L′ᵤ(cᵤ) ⊂Lᵤ(cᵤ).

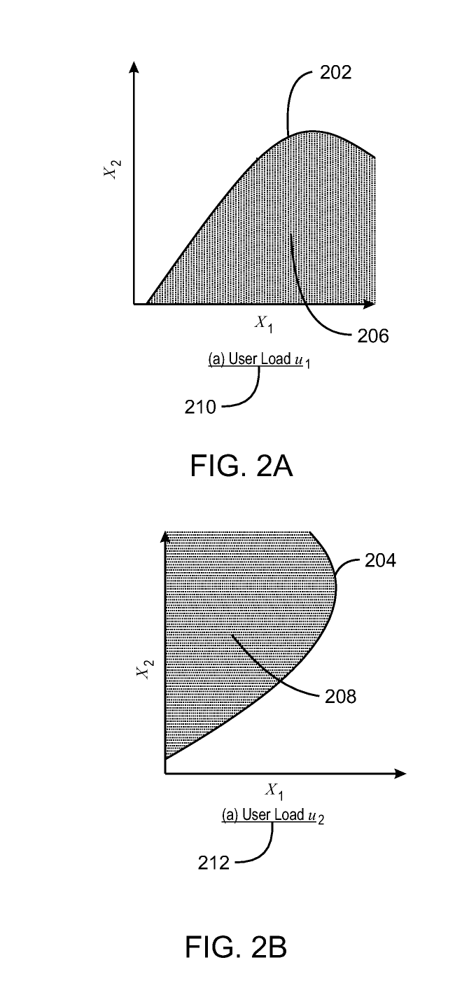

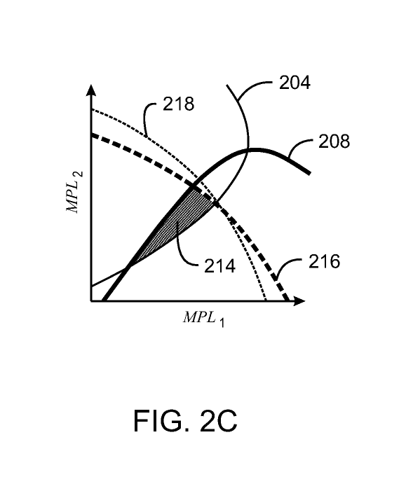

Isocontours and level sets for a user load can be illustrated with an n-dimensional plot, where there are n control parameters. Geometrically, the level set denotes the area below the surface spanned by the respective isocontour. FIGS. 2A and 2B illustrate isocontours 202 and 204. The shaded area below isocontour 202 is level set 206. The shaded area to the left of isocontour 204 is level set 208. In both examples, the user loads 210 and 212 are executed concurrently on the same machine.

If the interaction between two or more user loads is dominated by negative interactions between heterogeneous sets of queries, the resulting isocontour of each negative user load will be convex as shown in FIGS. 2A and 2B. Conversely, if positive interactions are dominant, then the isocontour will be non-convex.

The term Cᵤ may denote the set of service level objectives and [symbol] ᵤ(X) may denote the set of performance measurements of user load u taken with control parameter settings X. Accordingly, a relation ≦_{F} may be defined that allows a measurement [symbol] (X) to be defined as “better” than another measurement [symbol] (X′). The relation ≦_{F} defines an order on the two measurements as follows: [symbol] (X′)≦_{F} [symbol] (X) [symbol] ∀_{1≦i≦k}: [symbol] (X′)[i]≦ [symbol] (X)[i]. In this equation, [symbol] (X)[i] may denote the ith element of the tuple. Two measurements are not comparable if different pairs of their respective elements are ordered differently. Note that relation ≦_{F} can also be used to compare measurements [symbol] ᵤ with objectives Cᵤ.

From the workload management point of view, threshold settings that satisfy all objectives C=∪_{uεU} Cᵤ of the user loads are of interest. Any threshold settings that are located in the overlap of the level sets of all user loads U may satisfy this requirement. Formally, the operating envelope Oᵤ can be defined for a workload consisting of the user loads U as Oᵤ=∩_{uεU}∩_{uεC}_{ᵤ}Lᵤ(Cᵤ). The operating envelope is empty if the objectives are formulated such that no thresholds can be found to satisfy all of the objectives. Moreover, the operating envelope is bounded by the isocontours of the user loads recognized as convex or non-convex. In the event a new workload is introduced, previous measurements from similar workloads are combined in order to bound a search for appropriate MPL settings within the operating envelope for the new workload.

FIG. 2C shows the operating envelope 218 for a workload with two user loads, each having an average response time and a throughput objective. Operating envelope 214 is restricted by an average response time isocontour of load u₁ 216 and the throughput isocontours 202 and 204 of both user loads. An average response time isocontour of load u₂ 218 is always satisfied when the other objectives (202, 204, and 216) are met. Note that throughput varies over time and that the isocontours are not necessarily unimodal.

Once the operating envelope is found, a distance function that calculates the distance between points on different isocontours is defined. Utility functions for deciding how to make trade-offs can then be defined in terms of this distance function. For example, one isocontour may represent MPL settings under which one user load meets a throughput requirement, and another isocontour may represent MPL settings under which another user load meets an average response time per query requirement. One utility function may choose to maximize throughput of the first user load. Another utility function may choose to minimize the average response time of the second user load.

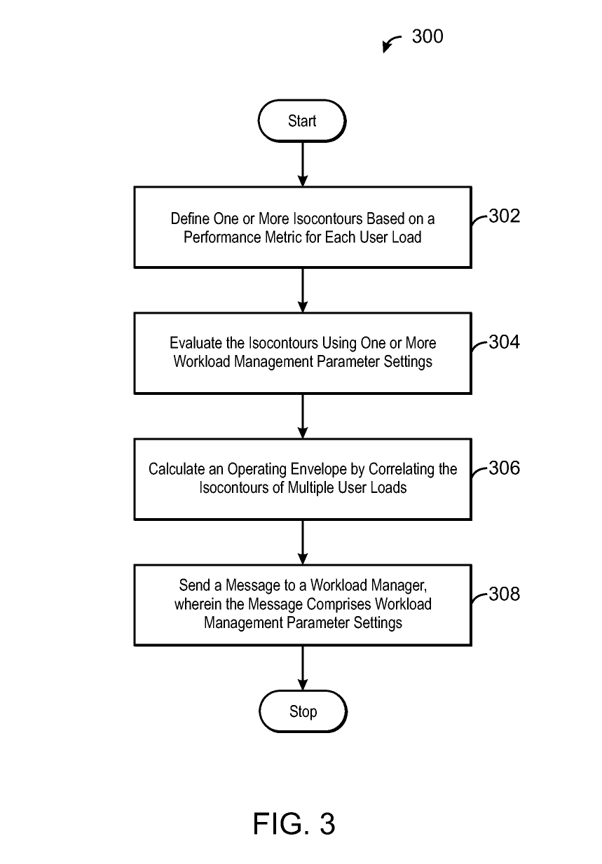

FIG. 3 is a process flow diagram showing a computer-executed method for multi-programming levels according to an embodiment. The method is generally referred to by the reference number 300. It should be understood that the process flow diagram is not intended to indicate a particular order of execution.

At block 302, an isocontour is defined based on the constant performance metric for each user load. At block 304, the isocontours are evaluated using one or more workload management parameter settings. The workload management parameter settings could include, for example, limiting the number of queries from each user load that execute concurrently at any point in time.

At block 306, an operating envelope is calculated by correlating the isocontours of multiple user loads. At block 308, a message is sent to a workload manager with workload management parameter settings. The workload management parameter settings enable the workload to execute within the calculated operating envelope for multiple user loads.

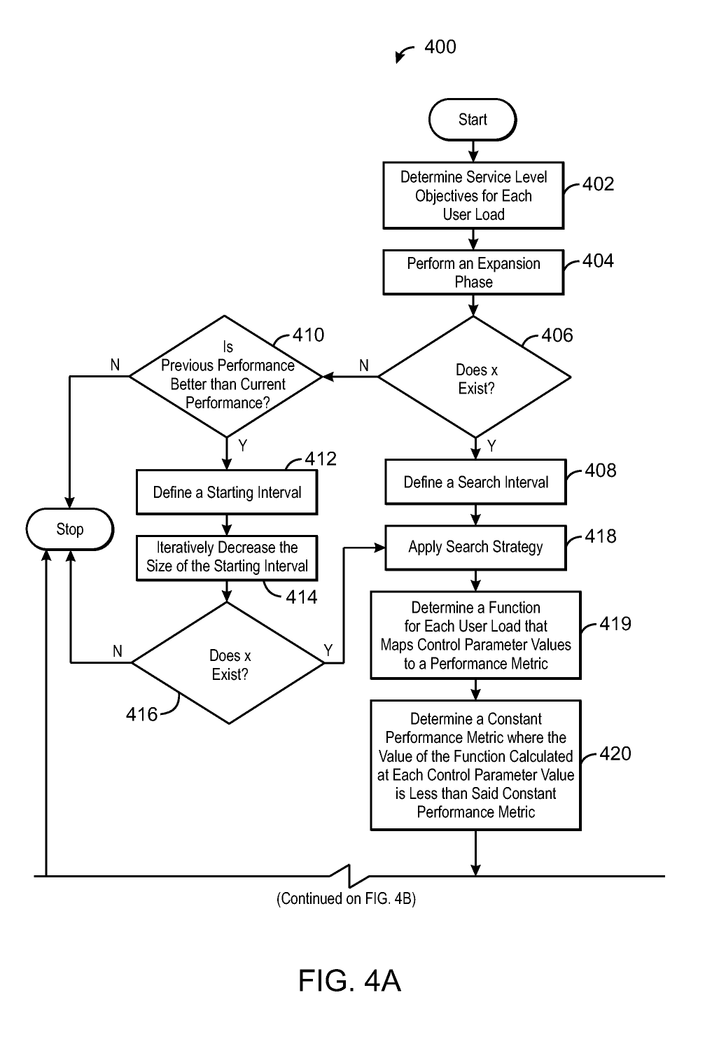

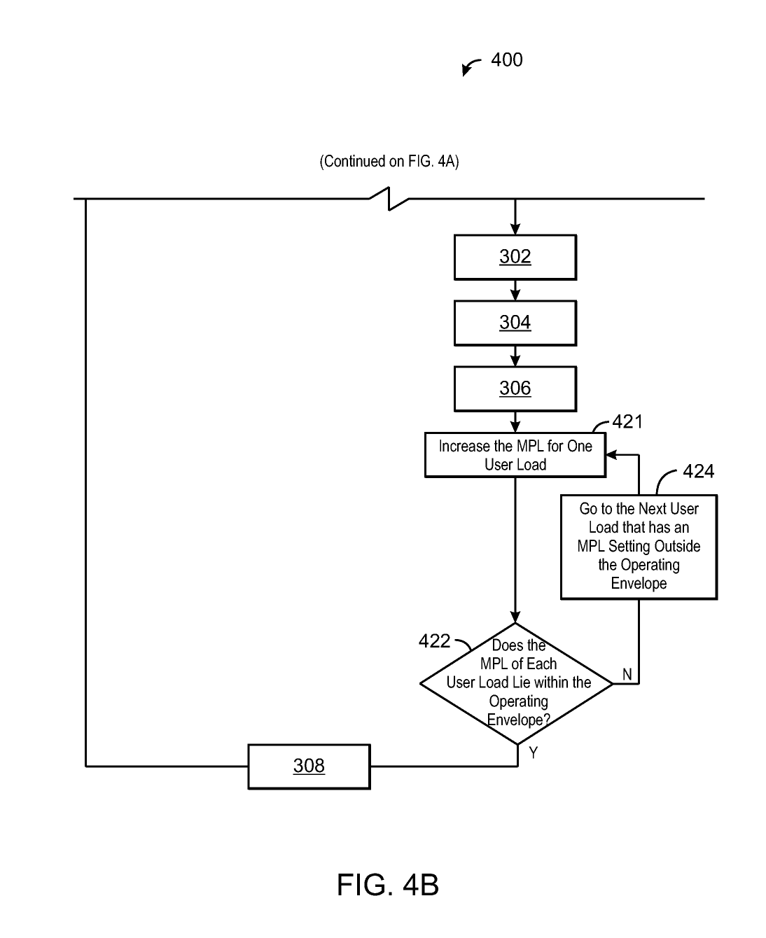

FIG. 4A and FIG. 4B are process flow diagrams showing a computer-executed method for multi-programming levels according to an embodiment. The method is generally referred to by the reference number 400. It should be understood that the process flow diagram is not intended to indicate a particular order of execution.

At block 402, the service level objectives are determined for each user load. At block 404, an expansion phase is performed by increasing the control parameter value exponentially at each service level objective in each user load until a value x is met that satisfies each service level objective in each user load. At block 406, a determination is made as to whether a value x exists. If the value x exists, process flow resumes at block 408. If the value x does not exist, process flow resumes at block 410.

At block 408, a search interval is defined where the minimum value is equal to the control parameter value prior to the value x, and the maximum value is equal to the control parameter value after the value x. At this point, a Fibonacci search is performed. Fibonacci searches are well known in the art. This particular version of the Fibonacci search completes when it has found the maximum point of the MPL throughput curve.

If the value x does not exist, at block 410 performance measurements are compared to determine if the previous performance measurement indicates better performance than the current performance measurement. If the previous performance measurement indicates better performance than the current performance measurement, the process flow resumes at block 412. If the if the previous performance measurement does not indicate better performance than the current performance measurement, the method 400 ends. At block 410, a slightly modified Fibonacci search is used. The modified Fibonacci search terminates as soon as it has found an MPL value that exceeds the designated objectives Cᵤ. If no control parameter value exists where the MPL value exceeds the designated objectives Cᵤ, the method 400 ends.

At block 412, a starting interval is defined where the minimum value is equal to the control parameter value with a better performance measurement than the current control parameter value, and the maximum value is equal to the current control parameter value. At block 414, the size of the starting interval is iteratively decreased until a value x is met that satisfies the service level objective for each user load.

At block 416, a determination is made as to whether the value x exists. If the value x exists, process flow resumes at block 418. If the value x does not exist, the method 400 ends. At block 418, a search strategy may be applied that searches within the starting interval or the search interval to identify the lowest control parameter value that satisfies the service level objectives for each user load. The search strategy applied may be a binary search. Process flow then continues to block 308 and block 310 from the method 300 in FIG. 3.

At block 419, a function may be determined for each user load that maps the control parameter values to a performance metric. It is important to note that the function may be defined independently of the system state. This ensures that the goal of the function is not to “maximize” system performance but rather to set the control parameters to meet the service level objective. If the system is over-engineered such that it has excess capacity, it may be possible to meet the service level objectives with an underutilized system. If the service level objectives cannot be met when the system is saturated, the method for setting the control parameters will terminate and not push the system beyond capacity.

At block 420, a constant performance metric is determined where the value of the function calculated at each control parameter value is less than said constant performance metric. Process flow then continues to blocks 302, 304, and block 306 from the method 300 in FIG. 3.

At block 421, the MPL for one user load whose current control parameter value is not within the operating envelope is increased. At block 422, it is determined if the MPL of each user load lies within the operating envelope. If the MPL of each user load lies within the operating envelope, process flow continues to block 308 from the method 300 in FIG. 3. If the MPL of each user load does not lie within the operating envelope, process flow resumes at block 424. At block 424 another user load whose current control parameter value is not within the operating envelope is selected. Process flow then resumes at block 421.

A high level view or pseudo-code of an algorithm that may be used to implement the method 400 is presented below:

| FindMinParam4UserLoad(u) | |
|---|---|
| x ← tuning parameter value for userload u | |
| xₚₚ ← //Next to last tuning parameter value | |
| xₚ ← x //Last tuning parameter value | |
| M′( u ) <-- NULL // previous measurement while TRUE | |
| increase tuning parameter x //e.g., exponentially | |
| [symbol] (u) ← result of running experiments with threshold x | |
| if ( [symbol] (u) ≦_{F} cᵤ) OR (M′(u)_{—} is NULL) | |
| p ←SearchInterval(u, xₚ, x) //Binary Search | |
| return p | |
| elseif [symbol] (u) ≦_{F} [symbol] (u) | |
| x′ ←ExtremumSearch (u, xₚₚ, x) //e.g., Fibonacci Search | |
| p ←SearchInterval (u, xₚ, x′) | |
| return p | |
| xₚₚ ← xₚ; xₚ ← x | |
| [symbol] (u) ← M(u) | |
| ExtremumSearch (u, xₘᵢₙ, xₘₐₓ) | |
| Fₙ = min{Fₖ\|xₘᵢₙ ≧ xₘₐₓ − Fₖ} | |
| left ← xₘₐₓ − Fₙ | |
| right ← xₘₐₓ | |
| mₗ ← right − Fₙ₋₁ | |
| mᵣ ← left − Fₙ₊₁ | |
| [symbol] (mᵣ) ←results of running experiment with threshold mᵣ | |
| if [symbol] (mₗ) ≦_{F} Cᵤ | |
| return mₗ | |
| [symbol] (mₗ) ←results of running experiment with threshold l | |
| if [symbol] (mᵣ) ≦_{F} Cᵤ | |
| return mᵣ | |
| if [symbol] (mₗ) ≦_{F} [symbol] (mᵣ) | |
| test ← mᵣ; high ← mₗ | |
| else | |
| test ← mₗ; high ← mᵣ | |
| for k ← 2 to n − 1 | |
| if [symbol] (high) ≦_{F} [symbol] (test) | |
| Swap (high, test) | |
| if high > test | |
| left ← test; test ← left + Fₙ₋ₖ | |
| else | |
| right ← test; test ← right − Fₙ₋ₖ | |
| Run experiment with threshold test | |
| if [symbol] (test) ≦_{F} Cᵤ | |
| return test | |
| FAIL | |
| Search (U) | |
| proceed ← TRUE | |
| while proceed | |
| V ←Ø | |
| for u ε U | |
| if Cᵤ ≦_{F} [symbol] ᵤ | //Performance measurements |
| | //with current tuning parameter values |
| | //violate constraints |

```
        V ← V ∪ {u}
    if V ≠Ø
        for u ε V
            x ← FindMinParam4UserLoad(u)
            Set tuning parameter value of userload u to x
            if constraints of all userloads met
                proceed ← FALSE
else proceed ← FALSE
```

### EXAMPLE

Assume again that throughput can be denoted as the service level objective and that there are two user loads, u₁ and u₂. The function ƒ is total throughput, and the system is in a steady state while not meeting the objective. For each user load, a suitable control parameter setting that meets the service level objectives of u is located. Then an expansion phase is performed at block 404 (FIG. 4A) that increases the control parameter value for each u until a value x is found that meets the objectives for each user load, or until the expansion phase has possibly “stepped over” a region where the objectives could be met. The exponentially increasing step width may cause a “step over” a particular region.

The result of the expansion phase, performed at block 404 (FIG. 4A) may be a search interval [xₘᵢₙ,xₘₐₓ], where xₘᵢₙ denotes the parameter control setting prior to the current setting xₘₐₓ, as shown at block 408 (FIG. 4A). If value x exists, a search strategy 418 (FIG. 4A) is applied within the interval to identify the minimum control parameter value that satisfies the service level objectives. This search strategy may be a binary search.

If value x does not exist, at block 410 (FIG. 4A) it can be determined that it has stepped over a suitable setting, if the previous performance measurement [symbol] ′ indicates better performance than the current measurement. The performance measurements are compared by searching for an interval where the lower point violates the objectives and the upper points meet the objectives, such as [symbol] (u)≦Cᵤ.

The starting interval, determined at block 412 (FIG. 4A), is obtained using a modified Fibonacci search. The modified Fibonacci search is effective at this point due to the load performance curve for single user load being a unimodal function with the curve having only one maximum point. Once found, the size of the starting interval [xₘᵢₙ, xₘₐₓ] is iteratively decreased until a value x is found where Cᵤ is met, as shown at block 414 (FIG. 4A). After a value x is found where Cᵤ is met, a search strategy is applied on the interval [xₘᵢₙ, x] to find the minimum parameter value that satisfies the service level objective, as shown at block 418 (FIG. 4A). Otherwise, the method ends because there is no control parameter value that fulfills the service level objectives.

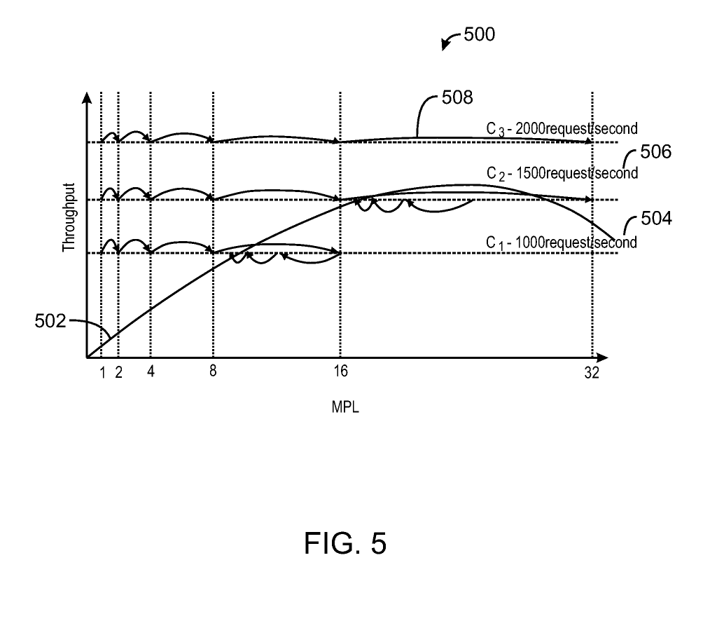

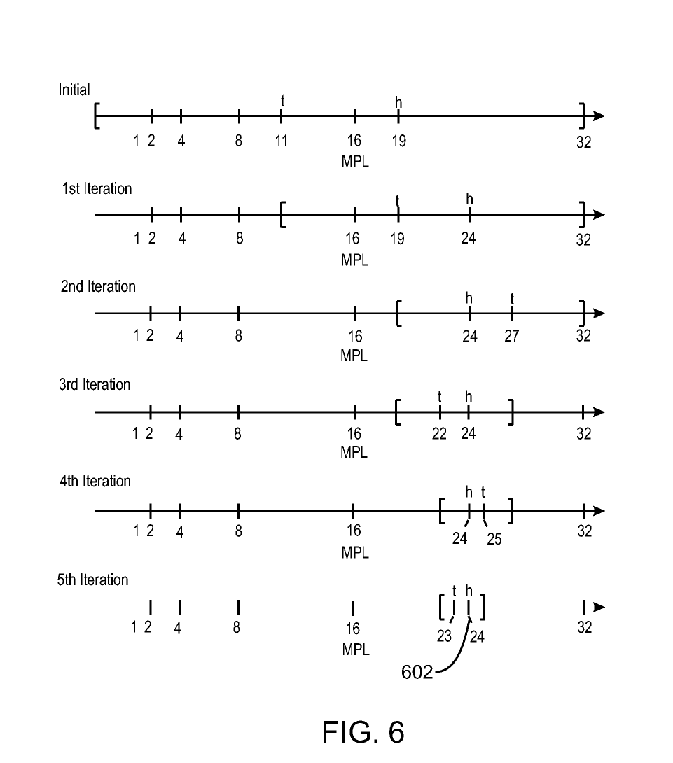

FIG. 5 illustrates the determination of the expansion phase, for example, as described at block 404 (FIG. 4A), using both search intervals and starting intervals. FIG. 5 shows an MPL throughput curve 502 for a single user load. The shape of throughput curve 502 is not known in advance. The figure also shows three different throughput objectives for user load u₁: 504, 506, and 508. For objective 504,

$${c}_{1} = 1000 \frac{requests}{second} ;$$

for objective 506,

$${c}_{2} = 1500 \frac{requests}{second} ;$$

and for objective 508,

$${c}_{3} = 2000 \frac{requests}{second} .$$

The steps shown in FIG. 5 correspond to an initial setting of MPL=1. For objective 504, the expansion phase, for example, performed at block 404 (FIG. 4A), stops the exponential increase of the MPL at MPL=16. This is the first value where throughput exceeds the threshold, resulting in an interval [8, 16]. At block 418 (FIG. 4A), a binary search is performed within the interval, resulting in an MPL value of 10, which is the smallest MPL value for which throughput exceeds c₁.

For objective 506, the expansion phase 404 (FIG. 4A) yields the interval [−2, 32] (throughput at MPL=16 is higher than throughput at MPL=32 and 34=F₉=min {Fₖ|8≧32−Fₖ}). The starting interval is [16, 24]. A binary search is done at block 418 (FIG. 4A) on the starting interval, resulting in an MPL value of 17.

For objective 508, the expansion phase 404 (FIG. 4A) results in the same interval as objective 506. FIG. 6 shows a visualization of the modified Fibonacci search for objective 508. The modified Fibonacci search shrinks the starting interval until it identifies MPL=24 that maximizes throughput. However, the throughput at MPL=24 does not exceed threshold c₃. As a result, the method ends and no search strategy is performed within the starting interval.

After the control parameter values have been found for each user load, the isocontour may be defined based on a performance metric for each user load at block 302 (FIG. 3). It may be straight forward to identify the type of control parameters for a given user load, however, complications may arise when finding the suitable settings for the control parameters. There are many parameters that influence the shape of an isocontour, such as the unexpected arrival of queries, resource requirements of the queries in the user load, and interactions between the queries. Some parameters can be gathered at compile-time, usually incurring significant overhead. Other parameters may only be available at runtime.

The isocontours are evaluated using the workload management settings at block 304 (FIG. 3). Then, operating envelope is calculated by correlating the isocontours of multiple user loads at block 306 (FIG. 3).

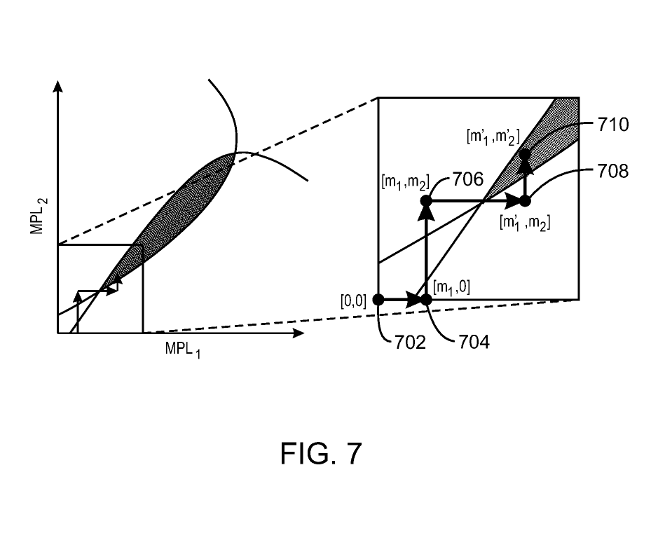

For each user load that violates their service level objectives such that their control parameters are not within the operating envelope, the control parameter values are optimized at block 420 (FIG. 4A). FIG. 7 shows a visualization of finding the MPL values of two user loads that lie within the operating envelope. Starting from point 702 at [0,0], at block 421 (FIG. 4B) the MPL of one user load is increased until it finds a value m₁ that meets the objectives of u₁. Since the throughput objectives for u₂ are not met at point 704 corresponding to [m₁, 0], at block 422 (FIG. 4B), the MPL of the second user load in increased, resulting in point 706 at [m₁, m₂]. At point 706, the objectives for u₂ are satisfied, but not for u₁. The search continues to “zig-zag” to point 708 at [m′₁, m₂] where neither objectives for u₁ nor u₂ are satisfied. Finally, the search finds point 710 at [m′₁, m′₂] within the operating envelope. At point 710, all objectives are satisfied. The workload parameter settings defined by the satisfactory MPL values are sent to the workload manager at block 308 (FIG. 3).

Non-Transitory Machine Readable Medium

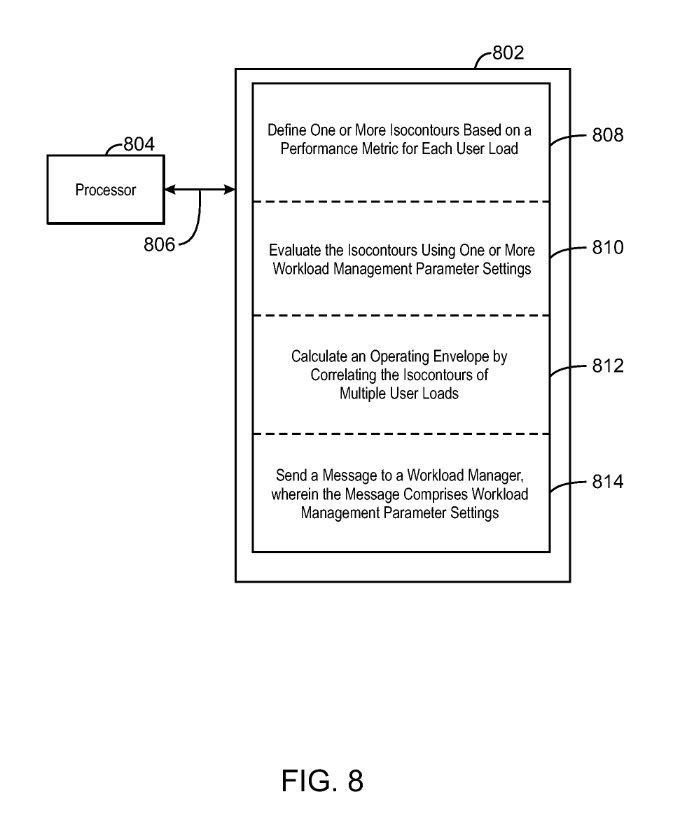

FIG. 8 is a block diagram showing a tangible, machine-readable medium that stores code that may determine multi-programming levels according to an embodiment of the present invention. The tangible, machine-readable medium is generally referred to by the reference number 800.

The tangible, machine-readable medium 800 may correspond to any storage device that can store computer-executed instructions, such as programming code or the like. For example, the tangible, machine-readable medium 800 may include any combinations of media discussed with respect to the storage 122 shown in FIG. 1A. When read and executed by a processor 804, the instructions stored on the tangible, machine-readable medium 800 are adapted to cause the processor 804 to determine multi-programming levels.

A region 808 of the tangible, machine-readable medium 800 stores machine-readable instructions that, when executed by the processor, define one or more isocontours based on a performance metric for each user load. A region 810 of the tangible, machine-readable medium 800 may store machine-readable instructions that, when executed by the processor, evaluate the isocontours using one or more workload management parameter settings. A region 812 of the tangible, machine-readable medium 800 may store machine-readable instructions that, when executed by the processor, calculate an operating envelope by correlating the isocontours of multiple user loads. A region 814 of the tangible, machine-readable medium 800 may store machine-readable instructions that, when executed by the processor, send a message to a workload manager, wherein the message comprises workload management parameter settings.

What is claimed is:

1. A computer system for determining multi-programming levels to meet objectives for queries running on a database system, comprising:
a processor that is adapted to execute stored instructions; and
a memory device that stores instructions, the memory device comprising
computer-executable code adapted to:
define one or more isocontours based on a performance metric for each user load;
evaluate the isocontours using one or more workload management parameter settings;
calculate an operating envelope by correlating the isocontours of multiple user loads; and
send a message to a workload manager, wherein the message comprises workload management parameter settings.

2. The system recited in claim 1, wherein the system includes a policy controller that communicates with a workload manager, the workload manager comprising an admission controller, a scheduler, or an execution controller, and wherein a message to the workload manager defines admission control, scheduling, or execution control policies.

3. The system recited in claim 2, wherein the system executes the admission controller, scheduler, or execution controller to place system conditions within the operating envelope.

4. The system recited in claim 1, wherein the system determines a function for each user load that maps control parameter values to the performance metric.

5. The system recited in claim 1, wherein a workload is subject to complex workload objectives.

6. The system recited in claim 1, wherein the workload manager communicates with a database management system.

7. The system recited in claim 1, wherein a control parameter value is increased exponentially at each service level objective in each user load until the control parameter value satisfies each service level objective for each user load.

8. The system recited in claim 7, wherein a search interval is defined by a minimum value equal to the control parameter value prior to the control parameter value satisfying the service level objective and a maximum value equal to the control parameter value after the control parameter value satisfying the service level objectives.

9. The system recited in claim 1, wherein the memory device comprises computer-executable code adapted to:
calculate a previous performance measurement;
calculate a current performance measurement;
define a starting interval by a minimum value equal to the an initial control parameter value and a maximum value equal to a current control parameter value if the previous performance measurement is better than the current performance measurement; and
decrease the size of the starting interval iteratively until the control parameter value satisfies each service level objective.

10. The system recited in claim 1, wherein a lowest control parameter value is found that satisfies each service level objective for each user load.

11. The system recited in claim 1, wherein the memory device comprises computer-executable code adapted to:
increase a multi-programming level for one user load if a corresponding control parameter value is not within the operating envelope;
determine if said multi-programming level for each user load is within the operating envelope;
return each said multi-programming level to the workload manager if each said multi-programming level is within the operating envelope; and
iterate until each said multi-programming level is within the operating envelope.

12. A method for determining multi-programming levels to meet objectives for queries running on a database system, comprising:
define one or more isocontours based on a performance metric for each user load;
evaluate the isocontours using one or more workload management parameter settings;
calculate an operating envelope by correlating the isocontours of multiple user loads; and
send a message to a workload manager, wherein the message comprises workload management parameter settings.

13. The method recited in claim 12, wherein a function is determined for each user load that maps control parameter values to the performance metric.

14. The method recited in claim 12, comprising increasing a control parameter value exponentially at each service level objective in each user load until a control parameter value is met that satisfies a service level objective in each user load.

15. The method recited in claim 14, wherein a search interval is defined by a minimum value equal to the control parameter value prior to the control parameter value satisfying the service level objective and a maximum value equal to the control parameter value after the control parameter value satisfying the service level objectives.

16. The method recited in claim 12, comprising:
calculating a previous performance measurement;
calculating a current performance measurement; and
defining a starting interval by a minimum value equal to an initial control parameter value and a maximum value equal to a current control parameter value if the previous performance measurement is better than the current performance measurement.

17. The method recited in claim 16, comprising decreasing the control parameter value iteratively until a control parameter value is met that satisfies each service level objective.

18. The method recited in claim 12, wherein a lowest control parameter value is found that satisfies each service level objective for each user load.

19. The method recited in claim 12, further comprising:
increasing a multi-programming level for one user load if the corresponding control parameter value is not within the operating envelope;
determining if said multi-programming level for each user load is within the operating envelope;
returning each said multi-programming level to a workload manager if each said multi-programming level is within the operating envelope; and
iterating until each said multi-programming level is within the operating envelope.

20. A non-transitory, computer-readable medium, comprising code configured to direct a processor to:
define one or more isocontours based on a performance metric for each user load;
evaluate the isocontours using one or more workload management parameter settings;
calculate an operating envelope by correlating the isocontours of multiple user loads; and
send a message to a workload manager, wherein the message comprises workload management parameter settings.
